(19) United States
(12) Patent Application Publication
(10) Pub. No.: US 2025/0298415 A1
(43) Pub. Date: Sep. 25, 2025

(54) REMOTE SUPPORT SYSTEM

(71) Applicant: TOYOTA JIDOSHA KABUSHIKI KAISHA, Toyota-shi (JP)

(72) Inventors: Hiromitsu URANO, Numazu-shi (JP); Takefumi Goto, Gotemba-shi (JP); Hiromitsu Kobayashi, Nagoya-shi (JP)

(73) Assignee: TOYOTA JIDOSHA KABUSHIKI KAISHA, Toyota-shi (JP)

(21) Appl. No.: 19/039,053

(22) Filed: Jan. 28, 2025

(30) Foreign Application Priority Data
Mar. 21, 2024 (JP) 2024-044677

(51) Int. Cl. G05D 1/617; G05D 1/224; G05D 101/15; G05D 109/10

(52) U.S. Cl. CPC G05D 1/617; G05D 1/2244; G05D 2101/15; G05D 2109/10

(57) ABSTRACT

A remote support system is for remote support for an automated driving vehicle, and includes one or more processors. The one or more processors are configured to: acquire support request information including content of a remote support request from the automated driving vehicle; acquire a concern message for notifying a concern that possibly arises if a remote supporter provides incorrect remote support to the automated driving vehicle, based on the support request information; and notify the remote supporter of the concern message through a remote support device operated by the remote supporter for the remote support.

### CROSS-REFERENCES TO RELATED APPLICATION

The present disclosure claims priority under 35 U.S.C. § 119 to Japanese Patent Application No. 2024-044677, filed on Mar. 21, 2024, which is incorporated herein by reference in its entirety.

### BACKGROUND

### Technical Field

The present disclosure relates to a technique for remotely supporting an automated driving vehicle.

### Background Art

JP 2021-189683 A discloses a driving assistance control device. The driving assistance control device presents driving assistance auxiliary information including an alert (for example, “Beware of rushing out”) to an operator based on a database of past accident patterns.

Moreover, JP 2022-188453 A discloses a vehicle remote operation device. The vehicle remote operation device determines that a remote operator is not in a proper operation state when the remote operator does not gaze at a gaze target area that should be gazed, and displays the gaze target area on a monitor in an emphasized manner. Furthermore, JP 2020-166541 A discloses an accident responsibility identification method for identifying where responsibility lies for an accident related to an automated driving vehicle.

### SUMMARY

It is desirable to further enhance the safety of remote support for an automated driving vehicle.

A remote support system according to the present disclosure is for remote support for an automated driving vehicle, and includes one or more processors. The one or more processors are configured to: acquire support request information including content of a remote support request from the automated driving vehicle; acquire a concern message for notifying a concern that possibly arises if a remote supporter provides incorrect remote support to the automated driving vehicle, based on the support request information; and notify the remote supporter of the concern message through a remote support device operated by the remote supporter for the remote support.

According to the present disclosure, the remote supporter is notified of a specific concern that possibly arises if the remote support is incorrectly performed. Therefore, the remote supporter can perform the remote support more cautiously and carefully. As a result, the safety of the remote support for the automated driving vehicle is improved. In addition, the remote supporter can more clearly recognize what to pay attention to in order to prevent the possible concern from actually occurring. This also contributes to improving the safety of the remote support.

### BRIEF DESCRIPTION OF THE DRAWINGS

FIG. 1 is a conceptual diagram used to describe a configuration of a remote support system according to an embodiment;

FIG. 2 is a block diagram illustrating an example of a functional configuration related to notification of a concern message by the remote support system;

FIG. 3 is a diagram used to describe a first example of acquisition of the concern message; and

FIG. 4 is a diagram used to describe a second example of acquisition of the concern message.

### DETAILED DESCRIPTION

Embodiments of the present disclosure will be described with reference to the accompanying drawings.

### 1. Remote Support System

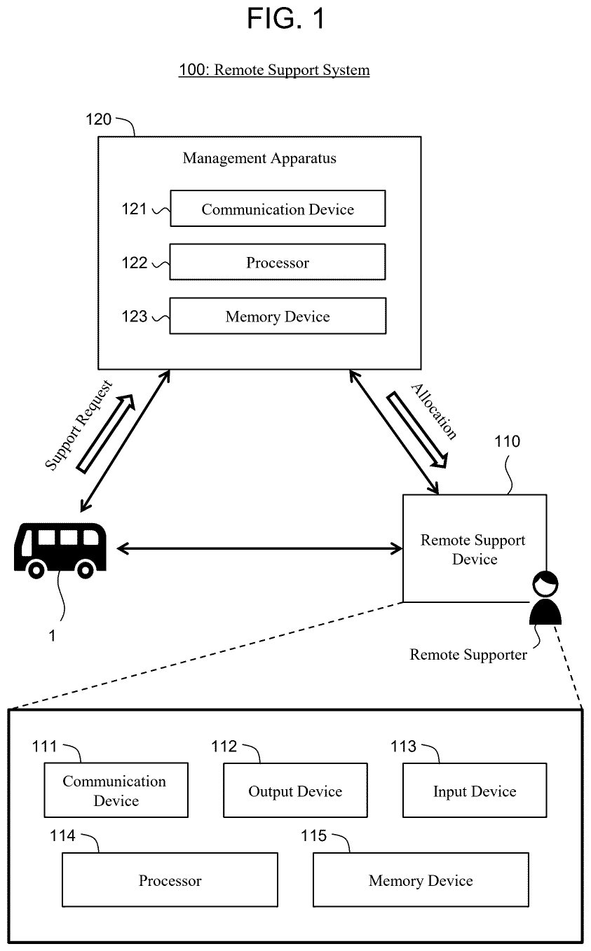

FIG. 1 is a conceptual diagram used to describe a configuration of a remote support system 100 according to the present embodiment. The remote support system 100 is a system for remote support for an automated driving vehicle 1. The remote support system 100 includes a remote support device 110 and a management apparatus 120. More specifically, the automated driving vehicle 1 has, for example, an automated driving function of level 4 or higher that does not need a driver. Examples of the automated driving vehicle 1 include an automated driving bus configured to operate in a limited area.

The automated driving vehicle 1 and the remote support system 100 can communicate with each other via a wireless communication network. The automated driving vehicle 1 communicates with the remote support system 100 and requests remote support as necessary. In response to this remote support request, the remote support system 100 remotely supports the automated driving vehicle 1. More specifically, a remote supporter (operator) who is a human remotely supports the automated driving vehicle 1 via the remote support system 100. The remote support system 100 can also be said to be a system that assists the remote support of the automated driving vehicle 1 by the remote supporter.

### 1-1. Remote Support Device

The remote support device 110 is a terminal device operated by a remote supporter when the remote supporter remotely supports the automated driving vehicle 1. That is, the remote support device 110 is configured to be used by the remote supporter for the remote support of the automated driving vehicle 1.

The remote support device 110 includes a communication device 111, an output device 112, an input device 113, one or more processors 114 (hereinafter, simply referred to as a processor 114), and one or more memory devices 115 (hereinafter, simply referred to as a memory device 115).

The communication device 111 communicates with the automated driving vehicle 1 and the management apparatus 120. The output device 112 outputs various kinds of information. For example, the output device 112 includes a display device. The display device displays various kinds of information to the remote supporter. In other words, the display device presents various kinds of information to the remote supporter by displaying the various kinds of information. In another example, the output device 112 may include a speaker. The input device 113 receives an input from the remote supporter. For example, the input device 113 is an interface for receiving an input from the remote supporter. Examples of the input device 113 include a touch panel, a keyboard, and a mouse.

The processor 114 executes various processes related to control of the remote support device 110. Examples of the processor 114 include a central processing unit (CPU), a graphics processing unit (GPU), an application specific integrated circuit (ASIC), and a field-programmable gate array (FPGA). The processor 114 may also be referred to as circuitry or processing circuitry. The memory device 115 stores various kinds of information. Examples of the memory device 115 include a volatile memory, a nonvolatile memory, a hard disk drive (HDD), and a solid state drive (SSD). The processor 114 that executes a control program and the memory device 115 may cooperate with each other to implement the functions of the remote support device 110. The control program is stored in the memory device 115. Alternatively, the control program may be recorded in a computer-readable recording medium.

### 1-2. Management Apparatus

The management apparatus 120 manages the remote support system 100. The management apparatus 120 may be configured by a plurality of servers that perform distributed processing. For example, the management apparatus 120 manages a plurality of remote supporters and a plurality of remote support devices 110. Also, in response to a remote support request from the automated driving vehicle 1, the management apparatus 120 allocates the remote supporter and the remote support device 110 to the remote support of the automated driving vehicle 1. The management apparatus 120 includes a communication device 121, one or more processors 122 (hereinafter, simply referred to as a processor 122), and one or more memory devices 123 (hereinafter, simply referred to as a memory device 123). The communication device 121 communicates with the automated driving vehicle 1 and the remote support device 110.

The processor 122 executes various processes. Examples of the processor 122 include a CPU, a GPU, an ASIC, and an FPGA. The processor 122 may also be referred to as circuitry or processing circuitry. The memory device 123 stores various kinds of information. Examples of the memory device 123 include a volatile memory, a nonvolatile memory, an HDD, and an SSD. The processor 122 that executes a management program and the memory device 123 may cooperate with each other to implement the functions of the management apparatus 120. The management program is stored in the memory device 123. Alternatively, the management program may be recorded in a computer-readable recording medium. The management program may be provided via a network.

### 1-3. Overview of Remote Support

The display device included in the output device 112 of the remote support device 110 displays information, such as the situation of an area in which the automated driving vehicle 1 travels and the position and state of the automated driving vehicle 1. The remote supporter monitors the information displayed on the display device. Also, the remote supporter remotely supports the automated driving vehicle 1 as necessary.

The remote support includes remote support (traveling support) related to traveling of the automated driving vehicle 1 and remote support (service support) related to a service provided by the automated driving vehicle 1.

The situation in which the traveling support by the remote supporter is necessary is, for example, a situation in which the automated driving is difficult. The automated driving vehicle 1 executes various vehicle processes during the execution of the automated driving. Examples of the vehicle processes include “recognition process”, “action determination process”, and “timing determination process”. Specifically, in the recognition process, the automated driving vehicle 1 recognizes the situation around the automated driving vehicle 1 using one or more recognition sensors. For example, the automated driving vehicle 1 recognizes a signal display of a traffic light (for example, a green light, a yellow light, a red light, or a right turn signal) using the camera. In the action determination process, the automated driving vehicle 1 determines whether or not to execute an action based on the result of the recognition process. Examples of the action of the automated driving vehicle 1 include starting, stopping, turning right, turning left, and changing lanes. In the timing determination process, the automated driving vehicle 1 determines an execution timing at which the action is executed.

The traveling support is support related to each of the vehicle processes described above. For example, when a traffic light installed at an intersection is exposed to sunlight, the accuracy of recognition of a signal display may be reduced. When the signal display cannot be accurately determined by the recognition process, the automated driving vehicle 1 needs the remote support for the signal recognition by the remote supporter. Thus, “support for recognition of a signal display of a traffic light” corresponds to an example of the traveling support. In addition, when the signal display cannot be determined, it is also difficult to determine what action should be executed at what timing. Therefore, the automated driving vehicle 1 also needs the remote support by the remote supporter for the action determination process and the timing determination process. Thus, “support for determination of the starting (Go/Not Go) and support for determination of timing of the starting” also correspond to examples of the traveling support.

In an example in which the automated driving vehicle 1 equipped with a door through which a passenger gets on and off provides a service of automatically opening and closing the door to the passenger, “support for determination of opening and closing of the door and determination of opening and closing timing” correspond to examples of the service support by the remote supporter. Furthermore, in an example in which the automated driving vehicle 1 provides a service of checking safety in the vehicle 1 to the passenger, “support for checking safety in the vehicle 1” corresponds to an example of the service support.

The overview of the flow of processes during the remote support of the automated driving vehicle 1 is as follows.

That is, when the remote support by the remote supporter is necessary, the automated driving vehicle 1 transmits to the remote support system 100, a “support request information REQ” indicating a request for the remote support. The remote support system 100 receives the support request information REQ from the automated driving vehicle 1. The support request information REQ includes the content of the remote support request from the automated driving vehicle 1.

The management apparatus 120 of the remote support system 100 notifies the remote supporter of the received support request information REQ through the remote support device 110, and requests the remote supporter to give an instruction to the automated driving vehicle 1. The remote supporter determines the instruction to the automated driving vehicle 1 in accordance with the content of the remote support request included in the support request information REQ. The remote supporter inputs the instruction to the remote support device 110. The remote support system 100 communicates with the automated driving vehicle 1 and notifies the automated driving vehicle 1 of the instruction from the remote supporter.

The automated driving vehicle 1 receives the instruction of the remote supporter from the remote support system 100. Then, in accordance with the instruction, the automated driving vehicle 1 performs traveling (i.e., automated driving) or performs a service, such as opening and closing of a door.

### 2. Notification of Concern Message

In order to further enhance the safety of the remote support for the automated driving vehicle 1, in the present embodiment, when the support request information REQ is received from the automated driving vehicle 1, the remote support system 100 acquires a “concern message MSG” based on the support request information REQ. The concern message MSG is a “message for notifying a concern that possibly arises if the remote supporter provides incorrect remote support to the automated driving vehicle 1”. Then, the remote support system 100 notifies the remote supporter of the concern message MSG through the remote support device 110.

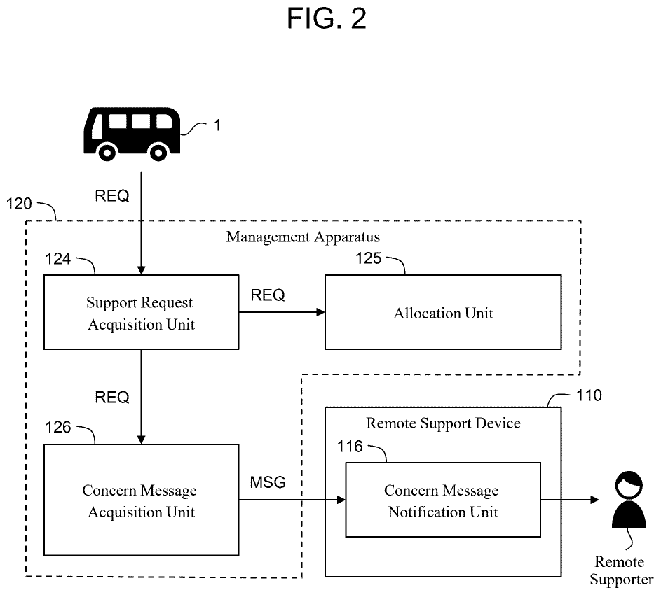

FIG. 2 is a block diagram illustrating an example of a functional configuration related to notification of the concern message MSG by the remote support system 100. The processes described with reference to FIG. 2 is executed by, for example, the management apparatus 120 and the remote support device 110 in cooperation with each other. Specifically, the management apparatus 120 includes a support request acquisition unit 124, an allocation unit 125, and a concern message acquisition unit 126 as functional blocks related to the notification of the concern message MSG. The remote support device 110 includes a concern message notification unit 116. It should be noted that these functional blocks are implemented by software when the management program and the control program that are described above are respectively executed by the processors 122 and 114.

The support request acquisition unit 124 acquires the support request information REQ transmitted from the automated driving vehicle 1. As described above, the support request information REQ includes “the content of the remote support request” from the automated driving vehicle 1. The content of the remote support request for the traveling support is, for example, “requesting support for starting the vehicle 1 while paying attention to pedestrians on the left side”. That is, the content of the remote support request may include a target (i.e., object) that the remote supporter should recognize or focus on. Also, the content of the remote support request for the service support is, for example, “requesting support for closing a door”. That is, the content of the remote support request may include the content of the service support requested to the remote supporter. The support request acquisition unit 124 transmits the support request information REQ to each of the allocation unit 125 and the concern message acquisition unit 126.

The allocation unit 125 allocates the remote supporter and the remote support device 110 to the remote support of the automated driving vehicle 1 based on the received support request information REQ.

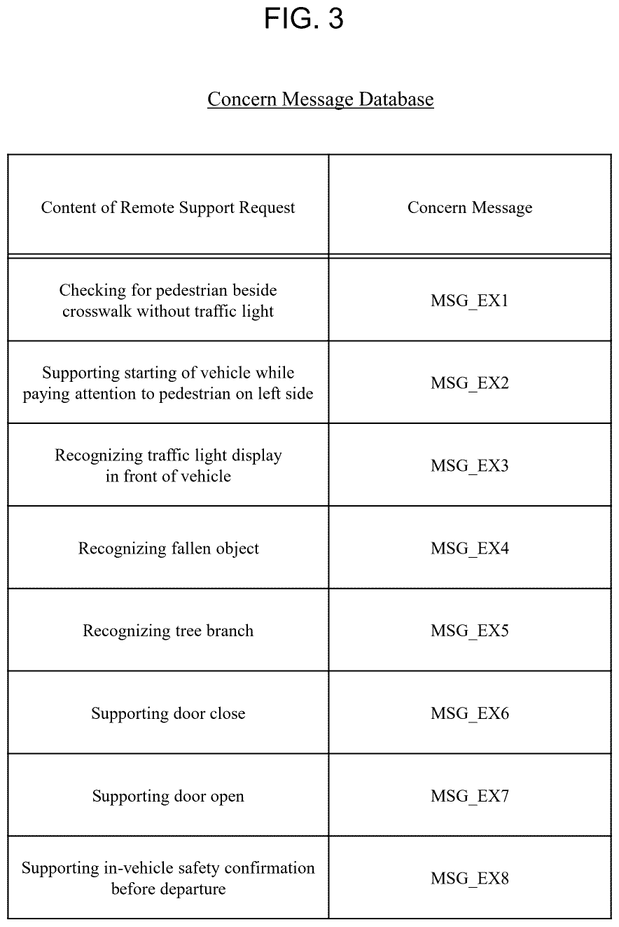

The concern message acquisition unit 126 acquires the concern message MSG based on the received support request information REQ. In addition, the concern message MSG does not indicate “the content itself of the remote support request (i.e., what the remote supporter does)”, but indicates “a concern that possibly arise if the remote supporter does not appropriately perform the requested remote support and performs incorrect remote support (i.e., what occurs when the remote supporter makes a mistake)”. Examples of combination of the content of the remote support request (in other words, the content of the requested remote support) and the concern message MSG will be described below with reference to FIG. 3.

### (Examples of Concern Message Acquisition)

FIG. 3 is a diagram used to describe a first example of the acquisition of the concern message MSG. In the first example, the concern message acquisition unit 126 uses a “concern message database” to acquire the concern message MSG. The concern message database indicates a correspondence relation (i.e., combination) between the contents of a plurality of predetermined types of remote support requests and a plurality of types of concern messages MSG.

In the examples of the concern message MSG shown in FIG. 3, MSG_EX1 to MSG_EX5 relate to the traveling support, and MSG_EX6 to MSG_EX8 relate to the service support.

To be specific, the concern message MSG_EX1 is a message for a remote support request for checking for a pedestrian beside a crosswalk without a traffic light when the automated driving vehicle 1 passes through the crosswalk. The concern message MSG_EX1 indicates that there is a possibility that “the vehicle 1 may collide with a pedestrian”, as a concern that possibly arises when the remote support according to the remote support request is inappropriate.

The concern message MSG_EX2 is a message for a remote support request for supporting the starting of the automated driving vehicle 1 while paying attention to a pedestrian on the left side, and indicates that there is a possibility of “the vehicle 1 and a pedestrian may collide” as the concern described above.

The concern message MSG_EX3 is a message for a remote support request for supporting recognition of a traffic light display in front of the vehicle 1, and indicates that there is a possibility that “the vehicle 1 may collide with a pedestrian or another vehicle” as the concern described above.

The concern message MSG_EX4 is a message for a remote support request for supporting recognition of a fallen object, and indicates, for example, that “when an object is not a paper bag but a small animal, the object may be run on” or that “when an object is not a paper bag but a stone, the bottom of the vehicle 1 may be damaged” as the concern described above.

The concern message MSG_EX5 is a message for a remote support request for supporting recognition of a tree branch, and indicates that there is a possibility of “the vehicle 1 may collide with a hard tree branch and damage the vehicle body” as the concern described above.

The concern message MSG_EX6 is a message for a remote support request for supporting closing a door of the automated driving vehicle 1, and indicates that there is a possibility that “a person may be caught by a door and injured, or the vehicle 1 may start while the person is caught” as the concern described above.

The concern message MSG_EX7 is a message for a remote support request for supporting opening a door of the automated driving vehicle 1, and indicates that there is a possibility that “a person leaning against a door may fall down to the outside of the vehicle 1” as the concern described above.

The concern message MSG_EX8 is a message for a remote support request for supporting in-vehicle safety confirmation before departure, and indicates that “a person who is not holding a strap may fall” as the concern described above.

The concern message database described above is stored in, for example, the memory device 123 of the management apparatus 120. The concern message acquisition unit 126 (processor 122) acquires the concern message MSG associated with the content of the remote support request included in the support request information REQ by referring to the concern message database.

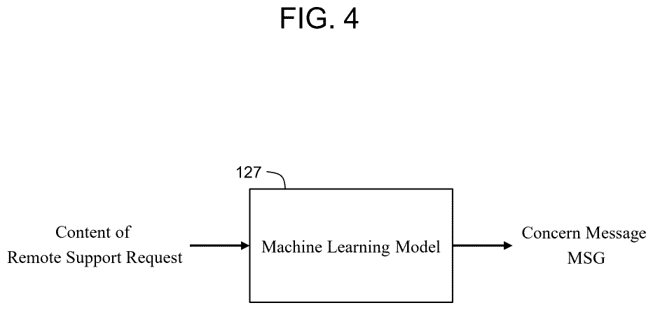

FIG. 4 is a diagram used to describe a second example of the acquisition of the concern message MSG. In the second example, the concern message acquisition unit 126 uses a “machine learning model 127” to acquire the concern message MSG.

As shown in FIG. 4, the machine learning model 127 has been trained to output a concern message MSG corresponding to the content of an input remote support request. The machine learning model 127 is stored in, for example, the memory device 123 of the management apparatus 120. The concern message acquisition unit 126 (processor 122) acquires the concern message MSG by inputting, to the machine learning model 127, the content of the remote support request included in the support request information REQ.

The concern message acquisition unit 126 transmits to a remote support device 110 allocated by the allocation unit 125, the concern message MSG acquired as described above together with the content of the remote support request.

The remote support device 110 receives the content of the remote support request and the concern message MSG from the management apparatus 120. The concern message notification unit 116 notifies the remote supporter of the concern message MSG together with the content of the remote support request.

Specifically, the concern message notification unit 116 displays, for example, a visual message as the concern message MSG on the output device 112 (display device). The visual message is, for example, at least one of a text and an image. The concern message notification unit 116 may also output a voice message as the concern message MSG from the output device 112 (speaker). Alternatively, both a visual message and a voice message may be output as the concern message MSG.

### 3. Effect

As described above, according to the remote support system 100 of the present embodiment, the remote supporter is notified of the concern message MSG based on the support request information REQ received from the automated driving vehicle 1. This makes it possible to notify the remote supporter of a specific concern that possibly arises if the remote support is incorrectly performed. Therefore, the remote supporter can perform the remote support more cautiously and carefully. As a result, the safety of the remote support for the automated driving vehicle 1 is improved.

Moreover, as a result of the concern message MSG being notified, the remote supporter can more clearly recognize what to pay attention to in order to prevent the possible concern from actually occurring. This also contributes to improving the safety of the remote support. In connection with this effect, the description is supplemented as follows. That is, in the example of the remote support request for “checking for a pedestrian beside a crosswalk without a traffic light” described above, the support requested to the remote supporter is only for checking for a pedestrian, and the remote supporter is not requested to provide support for checking for an oncoming vehicle, for example. Therefore, in this example, the remote support system 100 according to the present embodiment notifies the remote supporter of only the possibility of “collision between the vehicle 1 and a pedestrian” as the concern described above, as in the concern message MSG_EX1. On the other hand, in another example of the remote support request for requesting not only the check for a pedestrian but also a check for an oncoming vehicle, the remote support system 100 according to the present embodiment notifies the remote supporter of not only the possibility of “collision between the vehicle 1 and a pedestrian” but also the possibility of “collision between the vehicle 1 and an oncoming vehicle” as the concern described above.

What is claimed is:

1. A remote support system for remote support for an automated driving vehicle,
the remote support system comprising processing circuitry configured to:
acquire support request information including content of a remote support request from the automated driving vehicle;
acquire a concern message for notifying a concern that possibly arises if a remote supporter provides incorrect remote support to the automated driving vehicle, based on the support request information; and
notify the remote supporter of the concern message through a remote support device operated by the remote supporter for the remote support.

2. The remote support system according to claim 1, further comprising
one or more memory devices configured to store a concern message database indicating a correspondence relation between contents of a plurality of types of remote support requests and a plurality of types of concern messages, wherein
the processing circuitry is configured to refer to the concern message database to acquire the concern message associated with the content of the remote support request included in the support request information.

3. The remote support system according to claim 1, further comprising
one or more memory devices configured to store a machine learning model trained to output a concern message corresponding to input content of the remote support request, wherein
the processing circuitry is configured to acquire the concern message by inputting, to the machine learning model, the content of the remote support request included in the support request information.

4. The remote support system according to claim 1, wherein
the content of the remote support request includes a target that the remote supporter should recognize or focus on.

5. The remote support system according to claim 1. wherein
the content of the remote support request includes content of service support requested to the remote supporter.
